(19) United States
(12) Patent Application Publication
(10) Pub. No.: US 2018/0130086 A1
(43) Pub. Date: May 10, 2018

(54) METHOD AND SYSTEM FOR PROVIDING MOBILE REWARDS, GIFTS, COUPONS AND INCREMENTAL MOBILE DATA TO MOBILE & DIGITAL WALLET

(71) Applicants: SHAILESH NALAWADI, Morgan Hill, CA (US); ALFIAN TAN, San Francisco, CA (US); RAINA KUMRA GARDINER, Redwood city, CA (US)

(72) Inventors: SHAILESH NALAWADI, Morgan Hill, CA (US); ALFIAN TAN, San Francisco, CA (US); RAINA KUMRA GARDINER, Redwood city, CA (US)

(21) Appl. No.: 15/664,186

(22) Filed: Jul. 31, 2017

Related U.S. Application Data
(60) Provisional application No. 62/416,901, filed on Nov. 3, 2016.

(51) Int. Cl. G06Q 30/02; G06Q 20/36; G06F 8/70

(52) U.S. Cl. CPC G06Q 30/0233; G06N 99/005; G06F 8/70; G06Q 20/36

(57) ABSTRACT

In one aspect, a computerized method of a digital data wallet for managing downloading of data by a mobile device includes the step of providing a digital data wallet for a user, wherein one or more specified increments of data awarded to the user are stored in the digital data wallet. The method includes the step of providing a software development kit (SDK), wherein the SDK enables a mobile-device application administrator to issue a set of data rewards in a specified increment based on a specified criteria. The method includes the step of obtaining, with a digital data wallet application operating in a mobile device of the user, a mobile-device behavior of the user. The method includes the step of determinining that the mobile-device behavior of the user satisfies the specified criteria. The method includes the step of rewarding the specified increment of data to the digital data wallet to a data plan of the user.

### CROSS-REFERENCE TO RELATED APPLICATIONS

This application claims priority to U.S. Provisional Application No. 62/416,901, titled and METHOD AND SYSTEM FOR PROVIDING INCREMENTAL DATA REWARDS filed on 3 Nov. 2016. This provisional application is incorporated by reference in its entirety.

### FIELD OF THE INVENTION

This application relates generally to computer networking, and more specifically to a system, article of manufacture and method of providing incremental data rewards to a digital data wallet.

### DESCRIPTION OF THE RELATED ART

A user can utilize a mobile device (e.g. a smart phone, etc.) to access the Internet and access gift cards (e.g. e-gift cards, etc.), coupons (e.g. electronically deliverable and/or redeemable coupons, etc.) and vouchers (e.g. electronically deliverable and/or redeemable electronic vouchers, etc.) delivered via a mobile service. The user can subscribe with a data plan of a mobile carrier. The data plan can be a service that allows users to access the Internet (e.g. via a 3G, 4G, LTE networks, etc.). The mobile device can also include various non-native applications (e.g. music streaming applications, gaming applications, health applications, etc.). The various application can have administrators that may wish to influence user behavior. The administrators may also wish to obtain various user behavior analytics. Accordingly, useful and new improvements to motivate users to behave in specified ways with respect to mobile-device applications is desired.

### BRIEF SUMMARY OF THE INVENTION

In one aspect, a computerized method of a digital data wallet for managing downloading of data by a mobile device includes the step of providing a digital data wallet for a user, wherein one or more specified increments of data awarded to the user are stored in the digital data wallet. The digital wallet can be used to access the Internet and/or can be used for e-gifts, coupons, vouchers, cashback and other consumer incentives. The method includes the step of providing a software development kit (SDOK), wherein the SDK enables a mobile-device application administrator to issue a set of data rewards in a specified increment based on a specified criteria. The method includes the step of obtaining, with a digital data wallet application operating in a mobile device of the user, a mobile-device behavior of the user. The method includes the step of determining that the mobile-device behavior of the user satisfies the specified criteria. The method includes the step of rewarding the specified increment of data to the digital data wallet to a data plan of the user.

Optionally, the digital data wallet can be an online web service that enables the user to store and control one or more incremental data rewards. The application can be any type of mobile application. The method can include the step of aggregating a set of multiple data rewards from a plurality of mobile-device application administrators in the digital data wallet based on a set of user behavior with respect to a plurality of mobile-device applications. The method can include the step of providing another digital data wallet of another user and enabling the user to share a portion of the data increments in the digital data wallet with the other digital data wallet.

### BRIEF DESCRIPTION OF THE DRAWINGS

FIG. 1 illustrates an example process for placing increments of data in a user's data wallet, according to some embodiments.

FIG. 2 illustrates an example process for redeeming increments of data, according to some embodiments.

FIG. 3 illustrates an example process for metering data usage in local applications, according to some embodiments.

FIG. 4 illustrates an example process of a data monitoring application, according to some embodiments.

FIG. 5 illustrates an example system for providing incremental data rewards to a user of a mobile device, according to some embodiments.

FIG. 6 depicts an exemplary computing system that can be configured to perform any one of the processes provided herein.

FIG. 7 is a block diagram of a sample computing environment that can be utilized to implement various embodiments.

FIG. 8 illustrates an example process of a digital data wallet for managing downloading of data, by a mobile device, according to some embodiments.

The Figures described above are a representative set, and are not an exhaustive with respect to embodying the invention.

### DESCRIPTION

Disclosed are a system, method, and article of manufacture for method and system for providing mobile rewards, gifts, coupons and incremental mobile data to mobile & digital wallet. The following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to ‘one embodiment,’ ‘an embodiment,’ ‘one example,’ or similar language means that a particular feature, structure, or characteristic described in connection with the embodiment is included in at least one embodiment of the present invention. Thus, appearances of the phrases ‘in one embodiment,’ ‘in an embodiment,’ and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### Definitions

Example definitions for some embodiments are now provided.

Application programming interface (API) can specify how software components of various systems interact with each other.

Data plan can be a service (e.g. offered by a mobile carrier) that allows users to access the Internet (e.g. via a 3G, 4G, LTE networks, etc.). Data plans can enable a user to ‘consume’ a set amount of data (e.g. data downloaded from the Internet, etc.) in a variety of costs and sizes depending on the respective mobile carrier.

Data wallet can be online wallet that is a program or web service that allows users to store and control their incremental data rewards and associated information. The data wallet can also provide a convenient and technologically quick method for consumers to redeem aggregated incremental data rewards for larger chunks of data. The digital wallet can be used to access the Internet and/or can be used for e-gifts, coupons, vouchers, cash back and other consumer incentives.

Software development kit (SDK) can be a set of software development tools.

Exemplary Methods

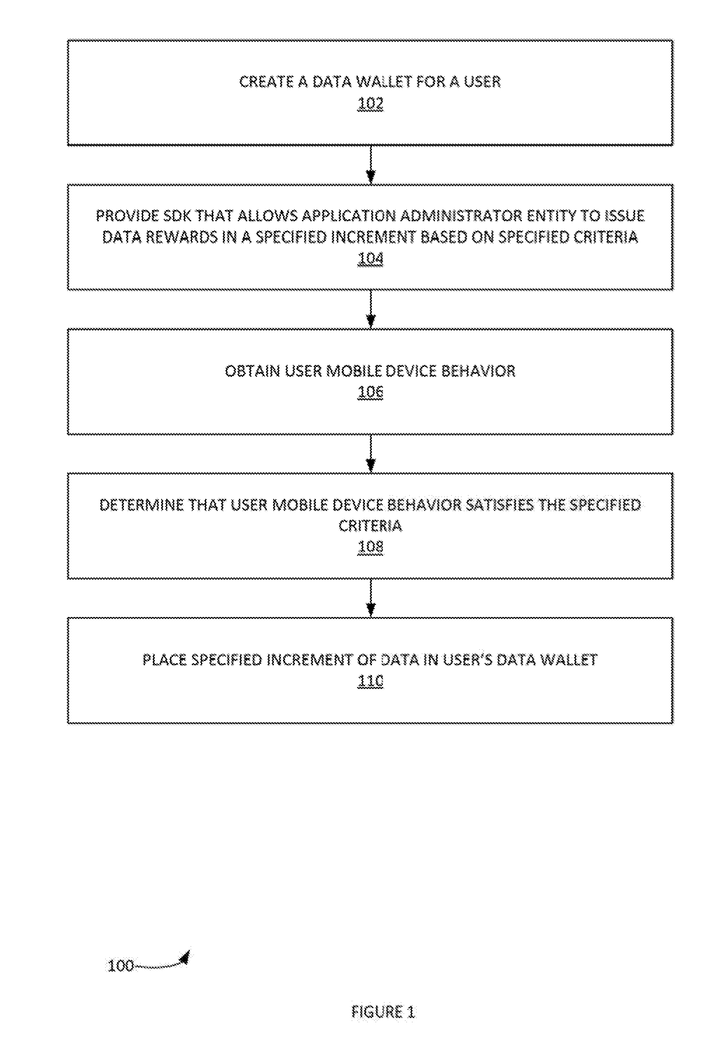

FIG. 1 illustrates an example process 100 for placing increments of data awarded to the user in a user's data wallet (e.g. a digital data wallet), according to some embodiments. The increments of data can be an amount of data consumption of a data plan. The digital wallet can be used to access the Internet and/or can be used for e-gifts, coupons, vouchers, cashback and other consumer incentives. The data plan can be a service (e.g. a mobile-device data plan offered by a mobile carrier, etc.) that allows users to access the Internet with a mobile device (e.g. via a 3G, 4G, LTE networks, etc.). Data plans can come in a variety of costs and sizes depending on the mobile carrier, and can include a set level/amount of data consumption for each customer for a periodic basis. In step 102, process 100 can create a data wallet for a user. Increments of data awarded to a user can be stored in the data wallet. A user can redeem any portion and/or all of the increments of data. In some examples, a user can share and/or otherwise assign any portion and/or all of the increments of data to other users' data wallets.

In step 104, process 100 can provide an SDK that allows an application administrator/developer entity to issue data rewards in a specified increment based on specified criteria. The SDK can enable application administrators/developers to set specific parameters regarding the awarding of increments of data to a user's data plan.

In step 106, process 100 can obtain user mobile device behavior. In step 108, process 100 can determine that user mobile device behavior satisfies the specified criteria. Process 100 can be implemented by a data-wallet application installed and operating in the user's mobile device. The data-wallet application can monitor (and store) the various analytics of other applications (e.g. non-native applications, etc.) also operative in the user's mobile device. The data-wallet application can determine if a user mobile device behavior satisfies the specified criteria. In step 110, process 100 can place specified increment of data in user's data wallet. A user can aggregate multiple data rewards in the data wallet. Process 100 can be repeated based on user mobile device behavior, application administrator reward plans, etc. Process 100 can be implemented in parallel as a user can utilize more than one application at a time.

In one example, a user mobile device behavior can be listening to a certain number of songs on a music streaming application. For example, a music streaming application administrator can provide a plan that it will reward the user five (5) megabytes (MB) of data to the user's data wallet if the user listens to five (5) songs on the music streaming application. The data-wallet application can monitor the music streaming application. When the five (5) songs are played on the user's music streaming application, the data-wallet application can notify and data-wallet server. The data-wallet server can then place the five (5) MB of data in the user's data wallet. The data-wallet server can then charge the music stream application entity for the five (5) MB of data. A user can redeem data acquired from process 100 to access/download data (e.g. media files, web pages, etc.) from the Internet. In some embodiments, data can be utilized for communication via video chat and/or voice call services. In some embodiments, data can be utilized to upload media files and/or electronically communicate (e.g. via MMS, email, etc.) data through a cellular data network.

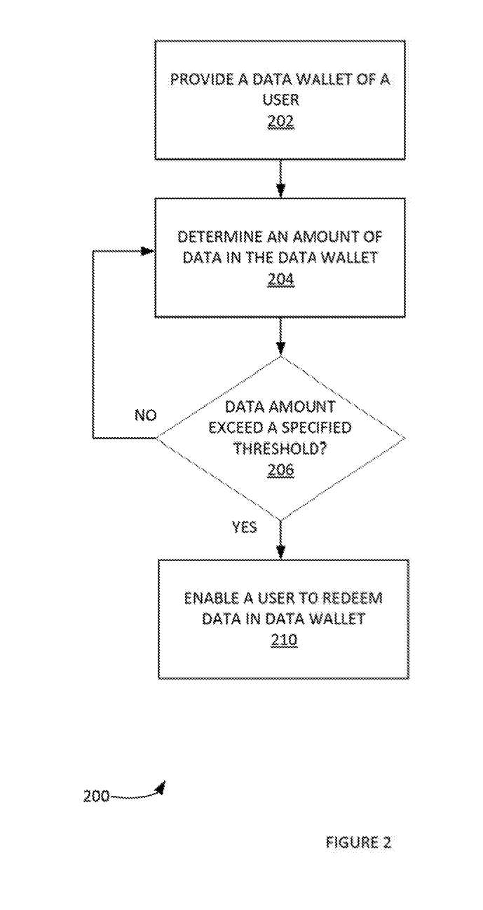

FIG. 2 illustrates an example process 200 for redeeming increments of data, according to some embodiments. It is noted that various cellular carriers can have parameters for when data can be redeemed with said cellular carrier. The increments of data provided by process 100 can be below the threshold of the cellular carrier's parameter. Accordingly, data can be saved in a user's data wallet until the parameter if met. More specifically, in step 202, process 200 can provide a data wallet of a user. In step 204, process 200 can determine an amount of data in the data wallet. In step 206, process 200 can determine if the amount of data in the data wallet exceeds a specified threshold. The specified threshold is set by the user's cellular carrier, if ‘no’, then process 200 can return to step 204. In ‘yes’, the process 200 can proceed to step 208. In step 208, the user can redeem the ‘chunk’ of data that is at the specified threshold. This chunk of data can be applied to the user's cellular data plan and used to enable the user to access the Internet via the cellular carrier's data network infrastructure.

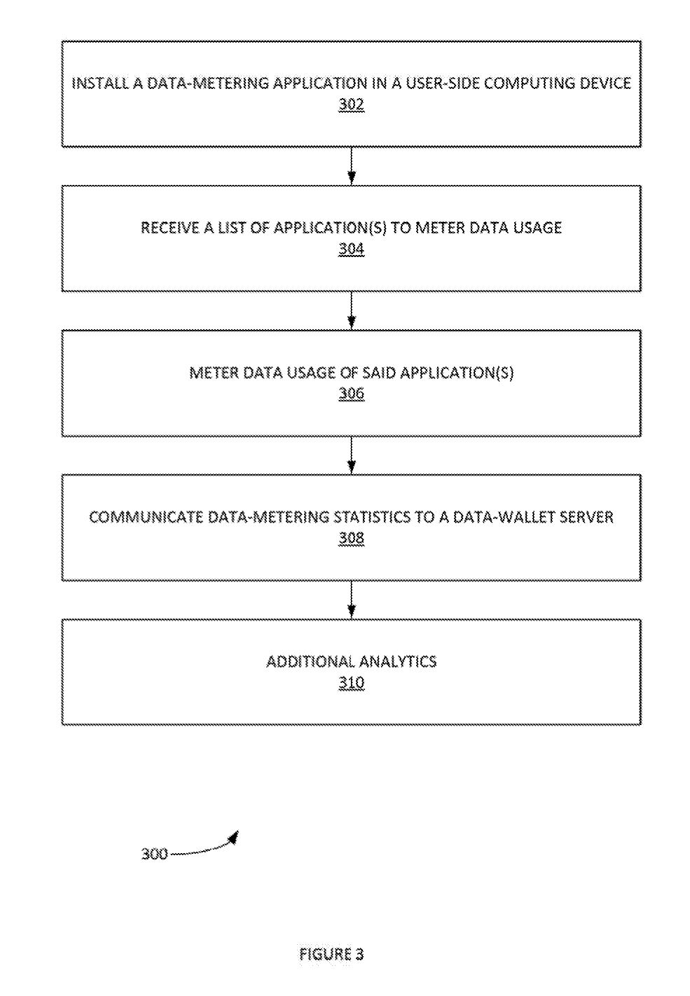

FIG. 3 illustrates an example process 300 for metering data usage (e.g. data consumption, etc.) in local applications, according to some embodiments. In step 302, process 300 can install a data-metering application in a user-side computing device. The data-metering application can be downloaded from an application distribution platform. The data-metering application can also download additional information regarding a user's account and various data-metering protocols from a data-wallet application.

In step 304, receive a list of application(s) to meter data usage. In some examples, the list can be received from the data-wallet server. Various application administrators/developers may want to provide micro-data rewards for various user application behavior (e.g. streaming music on a music streaming application, watching a video on a video application, purchasing a product or service with an e-commerce application, etc.). For example, an e-commerce application administrator may provide a reward of fifty (50) MB of data each time a user purchases a product using the e-commerce application.

In step 306, process 300 can meter data usage of said application(s). In step 308, process 300 can communicate data-metering statistics to a data-wallet server. Returning to the previous example, the e-commerce application can be place on the list associated with step 304. The specified action (e.g. purchasing a product via the e-commerce application) can be included in the list. The data-metering application can send notifications to the data wallet server each time the specified action is detected. Alternatively, the data-metering application can communicate all the relevant data-metering information to the data-wallet server on a periodic basis.

In step 310, process 300 can perform additional analytics operations (e.g. predictive analytics, business analytics, marketing analytics, etc.). These analytics can be on all data-metering information, user mobile device information (e.g. user location, other application usage, device type, etc.), user demographics, social networking information, etc. Various analytic operations can include machine learning algorithms, classification algorithms, etc. Analytics data can be provided to various application administrators/developers and/or other third-parties.

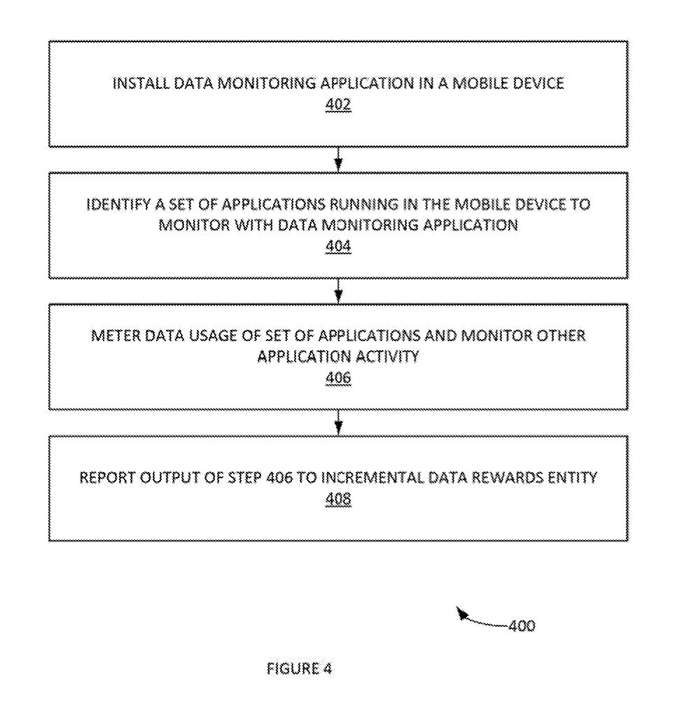

FIG. 4 illustrates an example process 400 of a data monitoring application, according to some embodiments. In step 402, process 400 can install a data-monitoring application in a mobile device. Data-monitoring application can meter data in any available application in the mobile device.

In step 404, process 400 can identify a set of applications running in the mobile device to monitor with data monitoring application. The applications can be identified as applications to be promoted for use by a user. For example, an administrator of an application can contract with an incremental data rewards entity to provide incremental data rewards to the mobile-device user when the user uses said application. In this way, a user can be incentivized to use an application.

In step 406, process 400 can meter data usage of the set of applications and monitor other application activity. For example, process 400 can monitor the cumulative period the application is used, the geographic locations of application use, etc. In step 408, process 400 can report output of step 406 to incremental data rewards entity (e.g. incremental data reward server(s) 510). Incremental data rewards can be stored in a data wallet associated with the user of the mobile device.

In some examples, processes 100-400 can enable various mobile-device application that use data plan to be ‘toll free’. Processes 100-400 can be used to ‘top off’ and/or otherwise recharge a user's data account.

Exemplary Computer Architecture and Systems

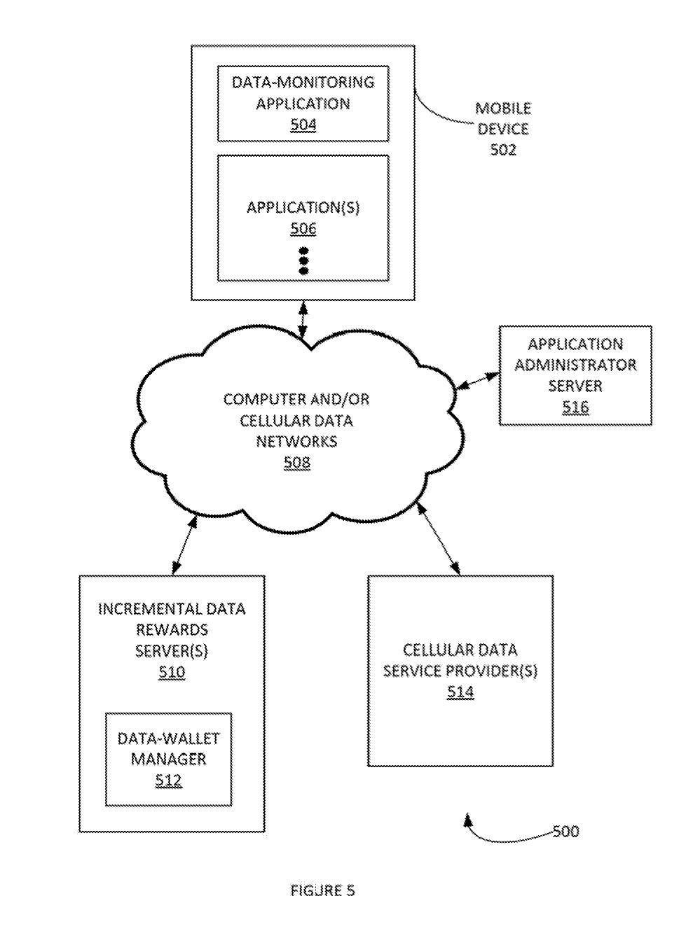

FIG. 5 illustrates an example system 500 for providing incremental (e.g. fractional) data rewards to a user of a mobile device, according to some embodiments. System 500 can include one or mobile devices 502. Mobile device 502 can include data-monitoring application 504 and application(s) 506. Mobile device 502 can electronically communicate with various servers via computer and/or cellular data networks 508 (e.g. the Internet, a local area network, an enterprise area network, a proprietary cellular network, etc.).

Data-monitoring application 504 can monitor the various activities of application(s) 506. Data-monitoring application 504 can meter data usage of application(s) 506 as well as any other activities performed by application(s) 506. Data-monitoring application 504 can communicate this information to incremental data rewards server(s) 510. Data-monitoring application 504 can be used to verify a user's actions for rewards but also for various analytics regimes.

Incremental data rewards server(s) 510 can perform various processes provided herein. Incremental data rewards server(s) 510 can manage profiles about a user's use of application(s) 506. Incremental data rewards server(s) 510 can manage an incremental rewards program whereby users are reward incremental quanta data as a reward for satisfying various application-usage parameters. Data rewards can be managed and stored by data-wallet manager 512. Data-wallet manager 512 can manage a data wallet (e.g. as provided supra). Incremental data rewards server(s) 510 can redeem data rewards from a data wallet with a user's cellular data server provider. Accordingly, incremental data rewards server(s) 510 can interact with cellular data server provider server 514 to redeem said incremental data rewards. Incremental data rewards server(s) 510 can also receive incremental data rewards schedules, parameters and plans from application administrator server 516, incremental data rewards server(s) 510 can communicate various application data metering information to application administrator server 516. In this way, an application administrator server 516 can verify application usage and/or other metrics. Incremental rewards server(s) 510 can include various functionalities (e.g. webservers, database managers, dashboard managers, etc.) to implement dashboard management and integration with a customer user interface. User can be used the dashboard to manage their accounts. User can use the dashboard for mobile phone data top-up/recharge operations, account balance checking, etc.

Incremental rewards server(s) 510 can also enable toll free and sponsored messaging applications (e.g. text message applications, multi-media messaging applications, etc.). Incremental rewards servers(s) 510 can enable user to transfer specified increments of data in their data wallet to other currencies and vouchers. Example currencies/assets can include, inter alia, national currencies, digital asset/currencies (e.g. Bitcoin, etc.), vouchers to e-commerce market places and the like. Users can use dashboard to also transfer these currencies/assets to other users. Additionally, incremental rewards server(s) 510 can implement prepaid and/or postpaid account management. Prepaid account management can also include multiple operator circles and data packs. Furthermore, data rewards (e.g. in megabytes increments, etc.) can be awarded using a sweepstakes (and/or other a form of lottery that were tied to products sold) models.

Incremental rewards server(s) 510 can enable entities to sponsor mobile-data rewards. In one example, a sponsor can enable users to exchange mobile-data rewards for sponsored Wi-Fi interchange access. In this way, earned data credits can be redeemable for other forms of connectivity. Incremental rewards server(s) 510 can display digital advertisements to users. Advertisement display can be a factor in rewarding data to the user's data wallet. In one example, lock-screen advertisements can be utilized. Other advertising models, such as mobile engagement retention and/or non-display based advertising system, can be utilized as well.

It is noted that data rewards can be applied retroactively. In one example, incremental rewards server(s) 510 can refund users for the data charges incurred for displaying video and image advertisements on their device.

Incremental data server(s) 510 can include various analytics, recommendation engines, sorting functionalities and machine-learning systems. In this way, incremental rewards server(s) 510 can perform analytics on user's data consumption and daily data usage. Incremental data server(s) 510 can analyze user behavior changes via various variables such as data incentive (e.g. values of data rewards, etc.), data usages, other user behaviors, etc. In this way, incremental data server(s) 510 can sort and order of promotions displayed to users based on machine learning and personalization analytics. Incremental data server(s) 510 can perform end-user evaluation via machine learning to detect fraud and high-quality users. Incremental data server(s) 510 can perform fraud detection on mobile data usage and earning of rewards patterns via machine learning. Incremental data server(s) 510 can perform data collection on user quality from enterprise customers and flagging of fraudulent events.

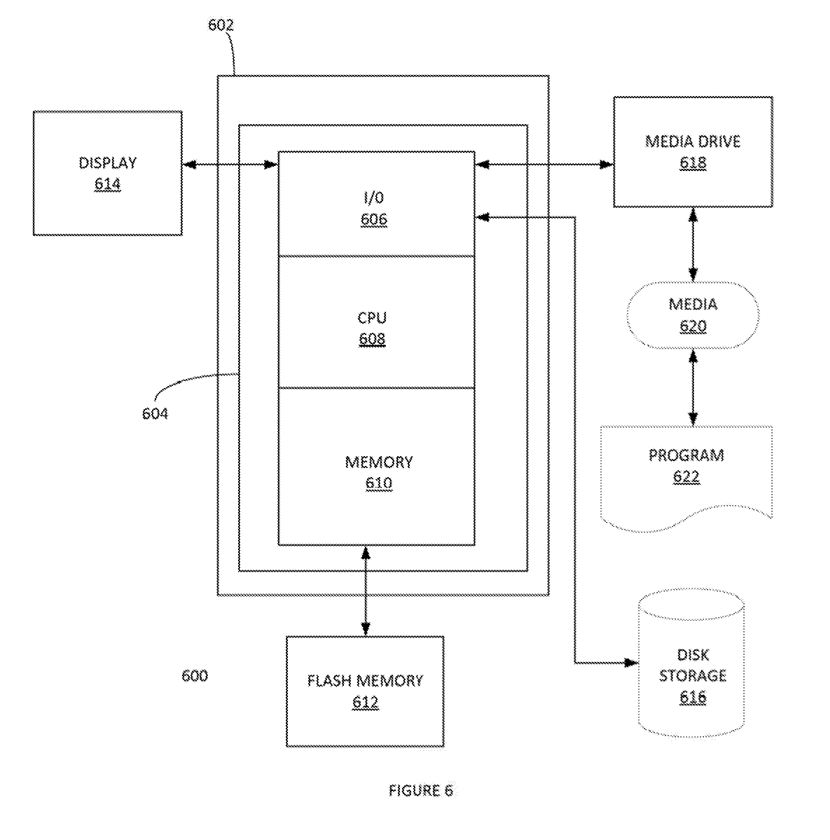

FIG. 6 depicts an exemplary computing system 600 that can be configured to perform any one of the processes provided herein. In this context, computing system 600 may include, for example, a processor, memory, storage, and I/O devices (e.g., monitor, keyboard, disk drive, Internet connection, etc.). However, computing system 600 may include circuitry or other specialized hardware for carrying out some or all aspects of the processes. In some operational settings, computing system 600 may be configured as a system that includes one or more units, each of which is configured to carry out some aspects of the processes either in software, hardware, or some combination thereof.

FIG. 6 depicts computing system 600 with a number of components that may be used to perform any of the processes described herein. The main system 602 includes a motherboard 604 having an I/O section 606, one or more central processing units (CPU) 608, and a memory section 610, which may have a flash memory card 612 related to it. The I/O section 606 can be connected to a display 614, a keyboard and/or other user input (not shown), a disk storage unit 616, and a media drive unit 618. The media drive unit 618 can read/write a computer-readable medium 620, which can contain programs 622 and/or data. Computing system 600 can include a web browser. Moreover, it is noted that computing system 600 can be configured to include additional systems in order to fulfill various functionalities. Computing system 600 can communicate with other computing devices based on various computer communication protocols such a Wi-Fi, Bluetooth® (and/or other standards for exchanging data over short distances includes those using short-wavelength radio transmissions), USB, Ethernet, cellular, an ultrasonic local area communication protocol, etc.

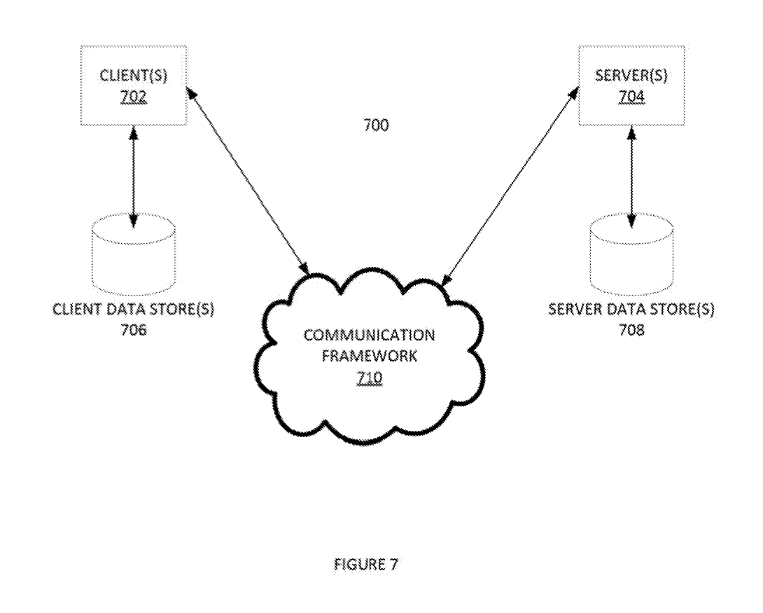

FIG. 7 is a block diagram of a sample computing environment 700 that can be utilized to implement various embodiments. The system 700 further illustrates a system that includes one or more client(s) 702. The client(s) 702 can be hardware and/or software (e.g., threads, processes, computing devices). The system 700 also includes one or more server(s) 704. The server(s) 704 can also be hardware and/or software (e.g., threads, processes, computing devices). One possible communication between a client 702 and a server 704 may be in the form of a data packet adapted to be transmitted between two or more computer processes. The system 700 includes a communication framework 710 that can be employed to facilitate communications between the client(s) 702 and the server(s) 704. The client(s) 702 are connected to one or more client data store(s) 706 that can be employed to store information local to the client(s) 702. Similarly, the server(s) 704 are connected to one or more server data store(s) 708 that can be employed to store information local to the server(s) 704. In some embodiments, system 700 can instead be a collection of remote computing services constituting a cloud-computing platform.

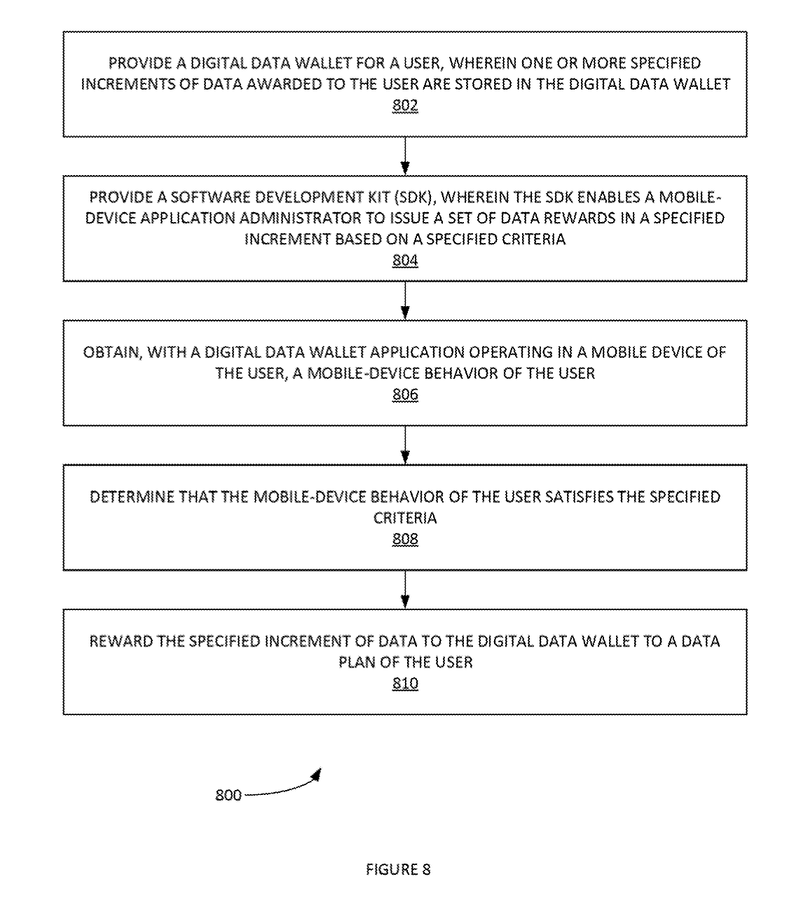

FIG. 8 illustrates an example process 800 of a digital data wallet for managing downloading of data by a mobile device, according to some embodiments. The digital wallet can be used for e-gifts, coupons, vouchers, cashback and other consumer incentives. In step 802, process 800 can provide a digital data wallet for a user, wherein one or more specified increments of data awarded to the user are stored in the digital data wallet. In step 804, process 800 can provide a software development kit (SDK). The SDK enables a mobile-device application administrator to issue a set of data rewards in a specified increment based on a specified criteria. In step 806, process 800 can obtain, with a digital data wallet application operating in a mobile device of the user, a mobile-device behavior of the user. In step 808, process 800 can determine that the mobile-device behavior of the user satisfies the specified criteria. In step 810, process 800 can reward the specified increment of data to the digital data wallet to a data plan of the user.

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it can be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

What is claimed as new and desired to be protected by Letters Patent of the United States is:

1. A computerized method of a digital data wallet for managing downloading of data by a mobile device comprising:
providing a digital data wallet for a user, wherein one or more specified increments of data awarded to the user are stored in the digital data wallet;
providing a software development kit (SDK), wherein the SDK enables a mobile-device application administrator to issue a set of data rewards in a specified increment based on a specified criteria;
obtaining, with a digital data wallet application operating in a mobile device of the user, a mobile-device behavior of the user;
determining that the mobile-device behavior of the user satisfies the specified criteria;
rewarding the specified increment of data to the digital data wallet to a data plan of the user.

2. The computerized method of claim 1, wherein the digital data wallet comprises an online web service that enables the user to store and control one or more incremental data rewards.

3. The computerized method of claim 2, wherein the application comprises a digital music streaming application

4. The computerized method of claim 3, wherein the specified criterion comprises streaming a specified number of songs on the music streaming application.

5. The computerized method of claim 1 further comprising:
aggregating a set of multiple data rewards from a plurality of mobile-device application administrators in the digital data wallet based on a set of user behavior with respect to a plurality of mobile-device applications.

6. The computerized method of claim 1 further comprising:
providing another digital data wallet of another user; and
enabling the user to share a portion of the data increments in the digital data wallet with the other digital data wallet.

7. The computerized method of claim 6, wherein the SDK enable application administrators to set a set of specific parameters for the awarding of increments of data to the data plan of the user.

8. The computerized method of claim 7, wherein the data plan comprises a service offered by a mobile carrier that allows the mobile device of the user to access the Internet and download data.

9. The computerized method of claim 8, wherein the specified increment of data added to the digital data wallet is used to access the Internet.

10. The computerized method of claim 8, wherein the specified increment of data added to the digital wallet is redeemed to access at least one of an electronic-gift, an electronic coupon, an electronic voucher, an electronic cashback and another consumer incentive.

11. A computer system of a digital data wallet for managing downloading of data by a mobile device comprising:
at least one processor configured to execute instructions;
a memory containing instructions when executed on the processor, causes the at least one processor to perform operations that:
provide a digital data wallet for a user, wherein one or more specified increments of data awarded to the user are stored in the digital data wallet;
provide a software development kit (SDK), wherein the SDK enables a mobile-device application administrator to issue a set of data rewards in a specified increment based on a specified criteria;
obtain, with a digital data wallet application operating in a mobile device of the user, a mobile-device behavior of the user;
determine that the mobile-device behavior of the user satisfies the specified criteria; and
reward the specified increment of data to the digital data wallet to a data plan of the user.

12. The computerized method of claim 11, wherein the digital data wallet comprises an online web service that enables the user to store and control one or more incremental data rewards.

13. The computerized method of claim 12, wherein the application comprises a digital music streaming application

14. The computerized method of claim 13, wherein the specified criterion comprises streaming a specified number of songs on the music streaming application.

15. The computerized method of claim 14, wherein the memory containing instructions when executed on the processor, causes the at least one processor to perform operations that:
aggregate a set of multiple data rewards from a plurality of mobile-device application administrators in the digital data wallet based on a set of user behavior with respect to a plurality of mobile-device applications.

16. The computerized method of claim 15, wherein the memory containing instructions when executed on the processor, causes the at least one processor to perform operations that:
provide another digital data wallet of another user; and
enable the user to share a portion of the data increments in the digital data wallet with the other digital data wallet.

17. The computerized method of claim 16, wherein the SDK enable application administrators to set a set of specific parameters for the awarding of increments of data to the data plan of the user.

18. The computerized method of claim 17, wherein the data plan comprises a service offered by a mobile carrier that allows the mobile device of the user to access the Internet and download data.

19. The computerized method of claim 18, wherein the specified increment of data added to the digital data wallet is used to access the Internet.

20. The computerized method of claim 18, wherein the specified increment of data added to the digital wallet is redeemed to access at least one of an electronic-gift, an electronic coupon, an electronic voucher, an electronic cashback and another consumer incentive.
